(19) United States
(12) Patent Application Publication
(10) Pub. No.: US 2014/0369190 A1
(43) Pub. Date: Dec. 18, 2014

(54) TIER-BASED CONGESTION CONTROL FOR MULTIMODE USER EQUIPMENT

(71) Applicant: Verizon Patent and Licensing Inc., Basking Ridge, NJ (US)

(72) Inventors: Yee Sin Chan, San Jose, CA (US); Arda Aksu, Martinez, CA (US); Raymond So, San Ramon, CA (US); Lalit R. Kotecha, San Ramon, CA (US)

(21) Appl. No.: 13/920,740

(22) Filed: Jun. 18, 2013

(51) Int. Cl. H04L 12/851

(52) U.S. Cl. CPC H04L 47/24
USPC 370/230

(57) ABSTRACT

A network device may receive, from a user device, a connection request. The connection request may correspond to a request to access a first network. The network device may determine a network congestion level associated with the first network. The network device may determine priority class information associated with the user device. The network device may selectively provide access to the first network based on the network congestion level and the priority class information. The network device may selectively provide access to a second network when access to the first network is denied.

### BACKGROUND

Access class barring may be used to control network load during periods of high congestion. Access class barring may be applied to user devices, such as smart phones, through randomly allocated access classes. User devices that are assigned to a barred access class may be prevented from connecting to a radio access network (“RAN”) for a period of time.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for tier-based congestion control;

FIG. 5 is a diagram of an example implementation relating to the example process shown in FIG. 4;

FIG. 6 is a diagram of another example implementation relating to the example process shown in FIG. 4;

FIG. 7 is a flow chart of an example process for tier-based congestion balancing; and

FIGS. 8A, 8B, and 8C are diagrams of an example implementation relating to the example process shown in FIG. 7.

### DETAILED DESCRIPTION

The following detailed description of example implementations refers to the accompanying drawings. The same reference numbers in different drawings may identify the same or similar elements.

A radio access network provider may reserve radio access technology resources, such as resources associated with a long term evolution (“LTE”) network, a code division multiple access data-optimized (“CDMA DO”) network, or the like, for use during periods of network congestion. Existing access class barring techniques may allow the network provider to randomly assign user devices to be barred from using available radio access technology resources for a period of time. However, randomly barring user devices may be undesirable, particularly where some of the barred user devices are associated with high priority users, or with users that lack other access capabilities. Implementations described herein may assist a radio access network provider in maintaining premium radio access technologies for high priority users during periods of network congestion, while allocating other radio access technologies to low priority users based on user device access capabilities, priority class information, and network congestion.

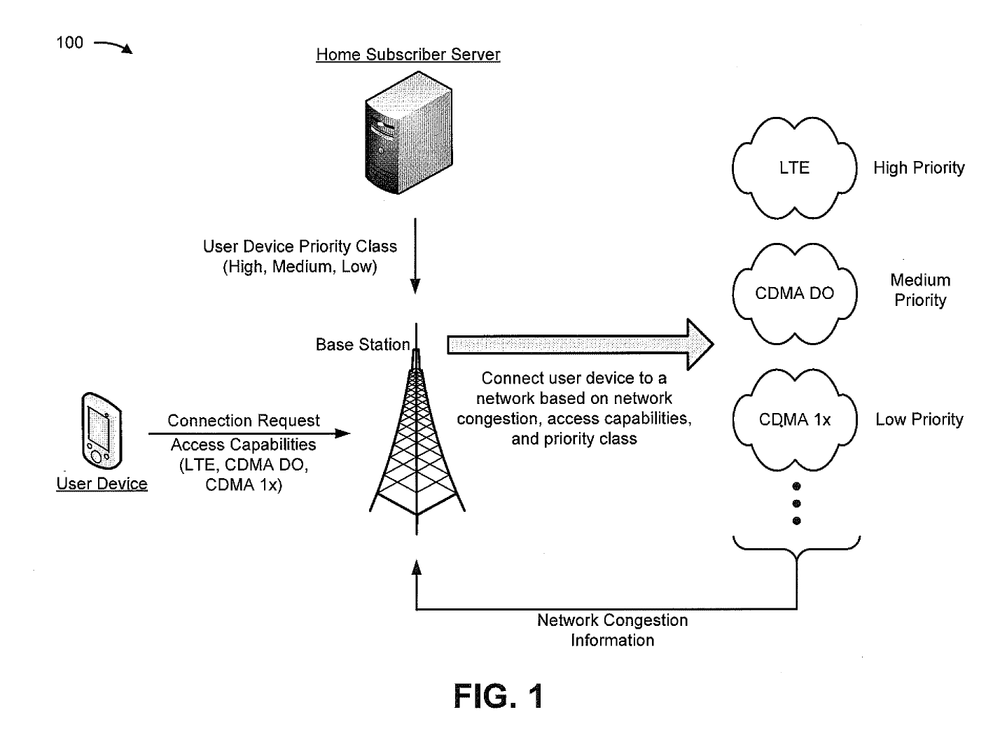

FIG. 1 is a diagram of an overview of an example implementation 100 described herein. As shown in FIG. 1, example implementation 100 may include a user device, a base station, a home subscriber server (“HSS”), and one or more networks. For example, the user device may include a mobile phone; the base station may include an eNodeB (“eNB”); the HSS may include one or more server computers; and the one or more networks may include an LTE network, a CDMA DO network, a CDMA one times radio transmission technology (“CDMA 1x”) network, or the like.

As shown in FIG. 1, the base station may receive a connection request from the user device. For example, the base station may receive a request to join an LTE network from the user device. The base station may determine that a threshold network congestion level (e.g., a utilization level), associated with the requested network, has been exceeded, and may process the connection request using tier-based admission procedures, as described herein.

As further shown in FIG. 1, the base station may determine the access capabilities of the user device. For example, the user device may have the capability to access an LTE network, a CDMA DO network, and a CDMA 1x network, as shown. The base station may receive, from the HSS, information identifying the user device's priority class (e.g., high, medium, or low). The base station may process the connection request based on the network congestion, the user device access capabilities, and the user device priority class. For example, assuming a congested network, a high priority user device may be assigned to the LTE network, a medium priority user device may be assigned to the CDMA DO network, and a low priority user device may be assigned to the CDMA 1x network. In this way, network congestion may be managed by allocating congested, premium network resources to high priority users and uncongested, non-premium network resources to low priority users.

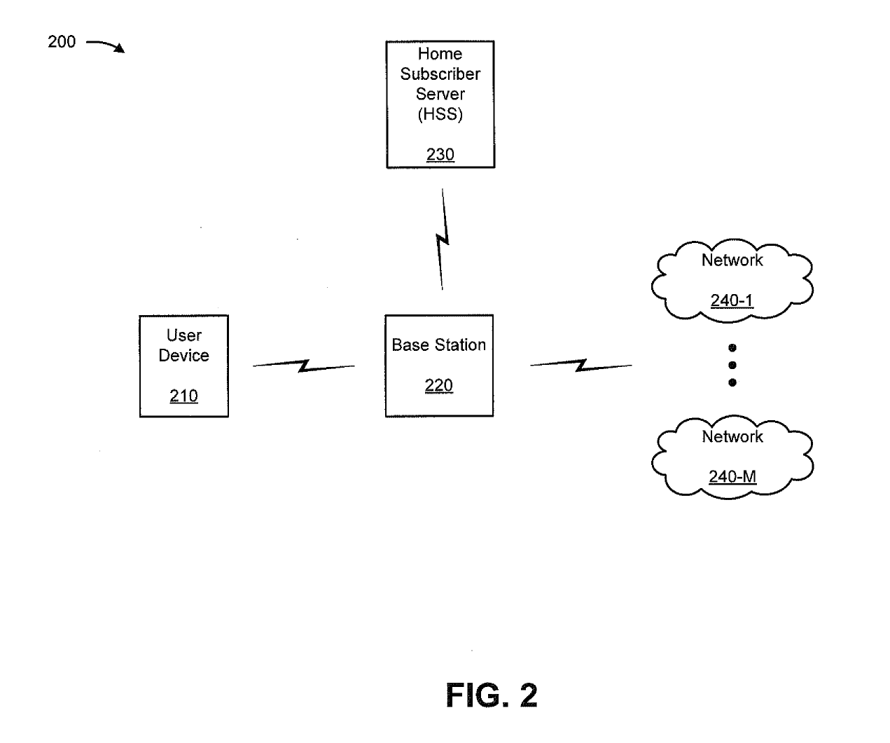

FIG. 2 is a diagram of an environment 200 in which systems and/or methods described herein may be implemented. As shown in FIG. 2, environment 200 may include a user device 210, a base station 220, a home subscriber server (“HSS”) 230, and one or more networks 240-1 through 240-M (M≧1) (hereinafter referred to collectively as “networks 240,” and individually as “network 240”). Devices of environment 200 may interconnect via wired connections, wireless connections, or a combination of wired and wireless connections.

User device 210 may include one or more devices capable connecting to a network, such as network 240 (e.g., via base station 220). For example, user device 210 may include a mobile phone (e.g., a smart phone), a radiotelephone, a personal communications system (“PCS”) terminal (e.g., that may combine a cellular radiotelephone with data processing and data communications capabilities), a personal digital assistant (“PDA”) (e.g., that may include a radiotelephone, a pager, Internet/intranet access, etc.), a computer (e.g., a desktop computer, a laptop computer, a tablet computer, etc.), a personal gaming system, and/or another similar type of device. In some implementations, user device 210 may send information associated with access capabilities of user device 210 to base station 220.

Base station 220 may include one or more devices capable of receiving, generating, processing, storing, and/or transmitting network traffic, such as media, audio, video, text, and/or other traffic, destined for and/or received from user device 210. In some implementations, base station 220 may include an eNB associated with an LTE network that receives traffic from and/or sends traffic to network 240 via a packet data network gateway and/or a serving gateway. Additionally, or alternatively, one or more base stations may be associated with a RAN that does not correspond to an LTE network. For example, base station 220 may be associated with a RAN that corresponds to a CDMA DO network, a CDMA 1x network, a Wi-Fi network, a WiMax network, or the like. Base station 220 may determine a network congestion level of network 240. Base station 220 may send traffic to and/or receive traffic from user device 210 via an air interface. In some implementations, base station 220 and may receive information identifying a priority class of user device 210 from HSS 230.

HSS 230 may include one or more devices that are capable of receiving, generating, processing, storing, and/or transmitting subscriber information, such as a user identification, a user authentication and/or authorization, user internet protocol (“IP”) information, priority class information, or the like. For example, HSS 230 may include a server, a user profile server function (“UPSF”), a home location register (“HLR”), an authentication center (“AuC”), or the like. HSS 230 may transmit subscriber information (e.g., information associated with a subscription class of user device 210) to base station 220 via a mobility management entity (“MME”), in some implementations. The subscriber information may include information identifying a priority class of user device 210 to base station 220.

Network 240 may include one or more wired and/or wireless networks. For example, network 240 may include a cellular network, a public land mobile network (“PLMN”), a first generation (“1G”) network, a second generation (“2G”) network, a third generation (“3G”) network, a fourth generation (“4G”) network, a fifth generation (“5G”) network, a CDMA 1x network, a CDMA DO network, an LTE network, and/or another network. Additionally, or alternatively, network 240 may include a Wi-Fi network, a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks. In some implementations, each network 240 (e.g., network 240-1, network 240-2, network 240-M, etc.) may represent a different type of network.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

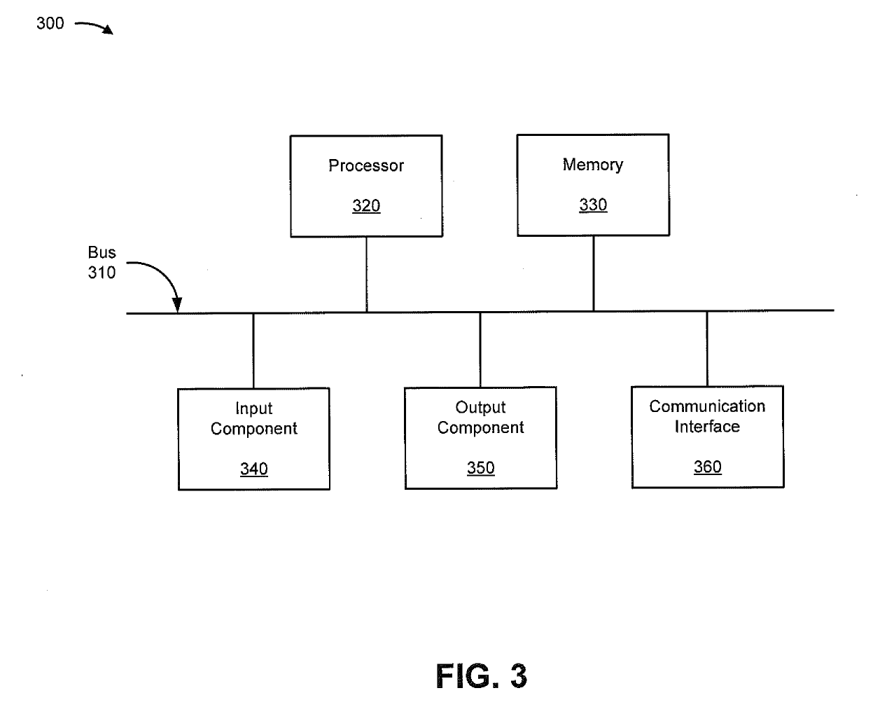

FIG. 3 is a diagram of example components of a device 300. Device 300 may correspond to user device 210, base station 220, and/or HSS 230. Additionally, or alternatively, each of user device 210, base station 220, and/or HSS 230 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing component (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, a Wi-Fi interface, a cellular network interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3.

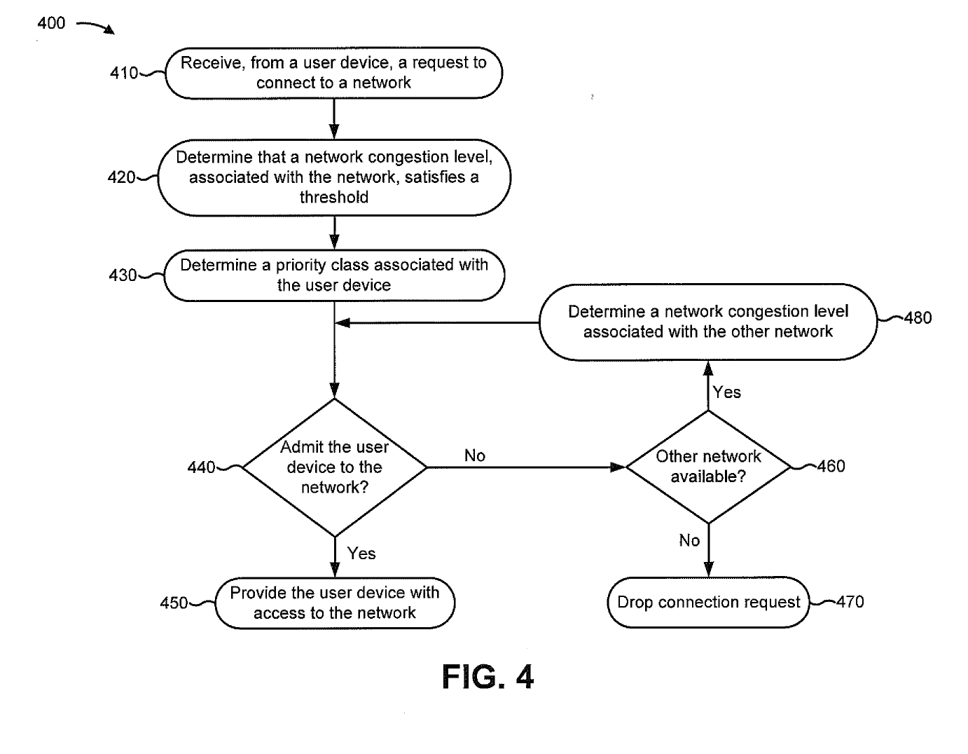

FIG. 4 is a flow chart of an example process 400 for providing tier-based congestion control. In some implementations, one or more process blocks of FIG. 4 may be performed by base station 220. Additionally, or alternatively, one or more process blocks of FIG. 4 may be performed by another device or a group of devices separate from or including base station 220, such as user device 210 and/or HSS 230.

As shown in FIG. 4, process 400 may include receiving, from a user device, a request to connect to a network (block 410). For example, base station 220 may receive a connection request from user device 210. In some implementations, the connection request may be based on access capabilities of user device 210. For example, user device 210 may be able to connect to one or more networks (e.g., network 240-1, network 240-2, network 240-M, etc.). An access capability may be a capability of user device 210 to connect to a network 240. For example, the access capabilities of user device 210 may identify networks 240 to which user device 210 may be connected.

Base station 220 may receive information identifying a type of user device 210, in some implementations. For example, user device 210 may identify itself to base station 220 as a particular type of smart phone. In this case, base station 220 may determine hardware associated with the type of smart phone. The hardware may identify the type of network accessible to user device 210, such as LTE, CDMA DO, or the like. In some implementations, base station 220 may receive information associated with the signal strength of networks 240 accessible to user device 210. For example, user device 210 may have hardware capable of accessing a network 240-M even though user device 210 may not be within range of network 240-M. In this case, base station 220 may determine that the access capabilities of user device 210 do not include network 240-M.

Base station 220 may identify a hierarchy of available networks, in some implementations. For example, base station 220 may order the networks 240 that are amongst the access capabilities of user device 210. In some implementations, the order of networks may be based on user preferences. For example, base station 220 may receive an ordered list of preferential networks from user device 210. In this case, base station 220 may receive a request from user device 210 to attempt connections to one or more networks in a specified order, such as to an LTE network, a CDMA DO network, and then a CDMA 1x network.

The order of networks may be based on network properties, such as network throughput, signal strength, or the like. For example, a first network may have a higher throughput rate than a second network. Alternatively, the second network may have a greater signal strength than the first network.

As shown in FIG. 4, process 400 may include determining that a network congestion level, associated with the network, satisfies a threshold (block 420). For example, base station 220 may determine that a network congestion level, associated with network 240, satisfies a threshold. In some implementations, a network congestion level may be based on a measurable network resource. The measurable network resource may include a quantity of radio-frequency (“RF”) channels, a quantity of network bandwidth, a network throughput, a quantity of bearer channels, a quantity of user devices, a quantity of users, or the like. For example, the network congestion level associated with network 240 may include the percentage of total RF channels already allocated to other user devices.

As shown in FIG. 4, process 400 may include determining a priority class associated with the user device (block 430). For example, base station 220 may receive priority class information, associated with user device 210, from HSS 230. In some implementations, base station 220 may receive, from HSS 230, subscription class information associated with user device 210, and may determine a priority class based on the subscription class information. For example, a first user device 210 associated with a user who pays higher fees and/or a higher surcharge may receive a higher priority class than a second user device 210 associated with a user who pays lower subscription fees and/or a lower surcharge (e.g., no surcharge). A priority class may include a classification (e.g., high or low; high, medium, or low; high, medium high, medium, medium low, or low; etc.) of user device 210 that correlates to the preferentiality of user device 210 in connecting to a network. In some implementations, base station 220 may determine a priority class based on information received from user device 210. For example, the connection request from user device 210 may include priority class information.

Base station 220 may determine the priority class associated with user device 210 based on a connection purpose, in some implementations. A connection purpose may include an intended transmission, such as an emergency call; an intended protocol, such as short message service (“SMS”) or multimedia messaging service (“MMS”); or the like. For example, base station 220 may determine a high priority class for user device 210, where the purpose of the transmission is an emergency call. In some implementations, base station 220 may determine the priority class associated with user device 210 based on a call origination location. For example, base station 220 may assign a high priority class to user device 210 when user device 210 is calling from within a hospital, a military base, a police station, or the like.

Base station 220 may determine the priority class associated with user device 210 based on the addition of a surcharge, in some implementations. For example, base station 220 may assign a high priority class to user device 210 when user device 210 pays an additional fee. In some implementations, base station 220 may determine the priority class associated with user device 210 based on the access capabilities associated with user device 210. For example, base station 220 may determine that user device 210 is unable to be assigned to a less congested network. In this case, base station 220 may raise the priority class of user device 210 to prevent rejection and disconnection.

As shown in FIG. 4, process 400 may include determining whether to admit the user device to the network (block 440). For example, base station 220 may determine whether to admit user device 210 to network 240. In some implementations, base station 220 may determine whether to admit user device 210 to network 240 based on the network congestion level. For example, base station 220 may admit user device 210 to network 240 when the network congestion level indicates the capability to handle additional traffic. The network congestion level may include multiple thresholds. For example, base station 220 may admit user device 210 to network 240 at a first threshold level of network congestion but deny admission at a second, higher, threshold level of network congestion.

At a given threshold level, base station 220 may determine whether to admit user device 210 to network 240 based on the priority class, in some implementations. For example, base station 220 may admit user device 210 to network 240, with a threshold level of network congestion when user device 210 is a high priority user device. In some implementations, base station 220 may admit multiple priority classes of user device 210 at the same threshold level. Additionally, or alternatively, base station 220 may have multiple thresholds for a single priority class. For example, base station 220 may admit a determined percentage of high priority user devices 210 at a first threshold level of network congestion, another determined percentage of high priority user devices 210 at a second threshold level, and may reject all high priority user devices 210 at a third threshold level.

In some implementations, base station 220 may determine whether to admit user device 210 to network 240 based on the access capabilities of user device 210. For example, base station 220 may deny admission to network 240 when user device 210 has the capability to access networks other than network 240.

Additionally, or alternatively, base station 220 may deny admission to network 240 when user device 210 has a signal strength associated with network 240 that is lower than a threshold. For example, base station 220 may determine that user device 210 is not to be connected to a first network when the signal strength associated with the first network does not satisfy a threshold, and when user device 210 is capable of accessing a second network with a signal strength that satisfies a threshold.

In some implementations, base station 220 may determine whether to admit user device 210 to network 240 based on one or more access rules. An access rule may be a preset determination by base station 220 as to whether user device 210 is to be admitted to network 240 based on a given set of factors. For example, an access rule may determine whether to admit user device 210 to network 240 at a given network congestion level and a given priority class.

As shown in FIG. 4, if the user device is to be admitted to the network, (block 440—YES), then process 400 may include providing the user device with access to the network (block 450). For example, base station 220 may determine, based on the level of network congestion and the priority class of user device 210, that user device 210 is to be connected to network 240, and may connect user device 210, accordingly.

As shown in FIG. 4, if the user device is not to be admitted to the network (block 440—NO), then process 400 may include determining whether another network is available (block 460). For example, base station 220 may determine a network 240 that has not been rejected as a potential connection for user device 210. In some implementations, base station 220 may determine the availability of another network 240 from the access capabilities of user device 210. For example, base station 220 may determine that user device 210 is capable of accessing network 240-1 and network 240-2, and may determine that network 240-2 is a network to which a connection has not been rejected. In this case, base station 220 may identify network 240-2 as a potential network to which user device 210 can be connected.

As shown in FIG. 4, if there is no other network available (block 460—NO), then process 400 may include dropping the connection request (block 470). For example, base station 220 may reject a connection between user device 210 and networks 240. In some implementations, base station 220 may block a new connection request for a period of time. For example, after rejecting user device 210, base station 220 may refuse a new connection request from user device 210 until a period of time has elapsed. In some implementations, base station 220 may block a new connection request based on the network congestion. For example, base station 220 may block a new connection request from user device 210 until the network congestion level associated with one or more rejected networks falls below a threshold.

As shown in FIG. 4, if the other network is available (block 460—YES), then process 400 may include determining a network congestion level associated with the other network (block 480) and determining whether to admit the user device to the other network (block 440). For example, base station 220 may determine a network congestion level associated with the other network 240, as described herein in connection with block 420. Base station 220 may determine whether to admit user device 210 to network 240 based on the network congestion level, the user device priority class, and/or the access capabilities.

Base station 220 may attempt to connect user device 210 to accessible networks sequentially, based on a preferential order, in some implementations. For example, base station 220 may determine to try to connect user device 210 to network 240-2, followed by network 240-3, followed by network 240-4. Alternatively, base station 220 may determine an optimal connection based on a preferential order, the priority classes, the access capabilities, and the access rules. For example, base station 220 may determine a score for network 240-2, a score for network 240-3, and a score for network 240-4, and may connect user device 210 to the highest scoring network.

In this way, base station 220 may allocate network connections based on network congestion, priority class, and/or user device access capabilities.

Although FIG. 4 shows example blocks of process 400, in some implementations, process 400 may include additional blocks, different blocks, fewer blocks, or differently arranged blocks than those depicted in FIG. 4. Further, one or more of the blocks of process 400 may be omitted in some implementations. Additionally, or alternatively, one or more of the blocks of process 400 may be performed in parallel.

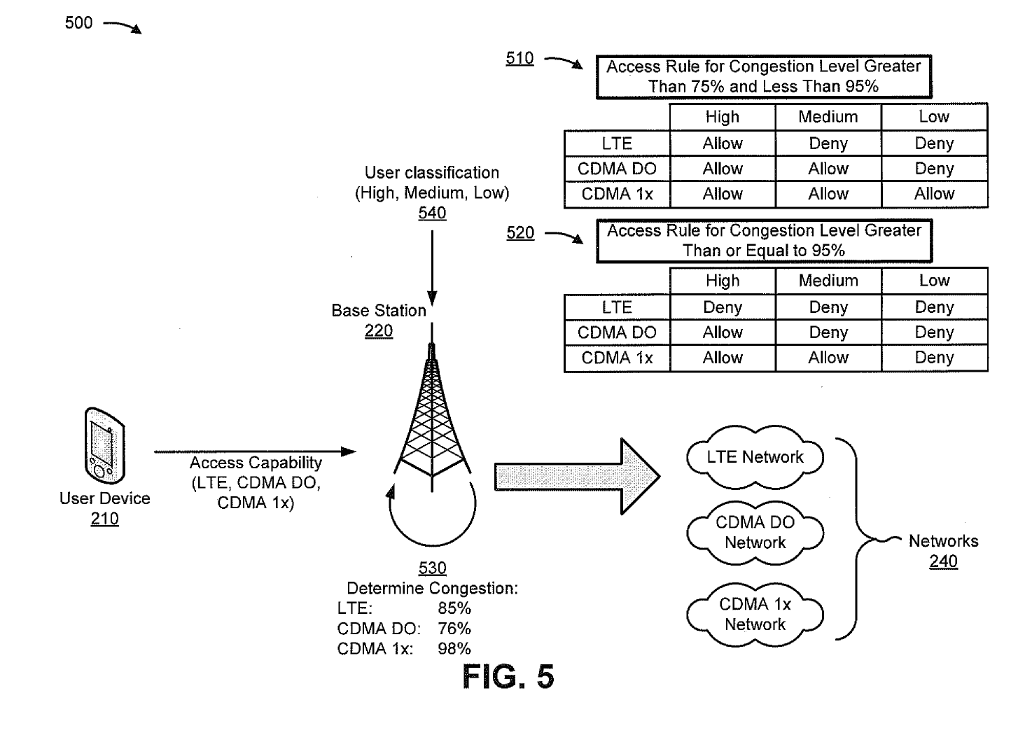

FIG. 5 is a diagram of an example implementation 500 relating to process 400 shown in FIG. 4. In example implementation 500, base station 220 may store access rules 510 and 520 to be used for determining whether to grant a connection request. An access rule may be a preset determination as to whether a connection request will be granted under a given set of conditions, such as network congestion level and priority class. For example, base station 220 may apply access rule 510 to a connection request by user device 210 when the network congestion level associated with a network is between 75% and 95%. Base station 220 may apply access rule 520 to a connection request by user device 210 when the network congestion level associated with a network is greater than or equal to 95%.

As shown in FIG. 5, base station 220 may receive a connection request from user device 210, that includes information associated with access capabilities of user device 210. For example, the access capabilities associated with user device 210 may identify networks accessible by user device 210, such as an LTE network, a CDMA DO network, and a CDMA 1x network.

As shown by reference number 530, base station 220 determines a network congestion level associated with the networks accessible by user device 210. For example, assume that base station 220 determines network congestion to be 85% for the LTE network, 76% for the CDMA DO network, and 98% for the CDMA 1x network. Assume that because the 85% network congestion level associated with the LTE network exceeds a threshold level of 75%, the LTE network is congested (e.g., based on access rule 510).

As shown by reference number 540, base station 220 determines a priority class for user device 210. For example, user device 210 may be classified as a priority class of high, medium, or low.

As further shown in FIG. 5, access rule 510 is to be applied when the congestion level of a network is between 75% and 95%, such as for the LTE network and CDMA DO network. Alternatively, access rule 520 is to be applied when the congestion level of a network is greater than or equal to 95%, such as for the CDMA 1x network.

In example implementation 500, assume that base station 220 attempts to connect user device 210 to each accessible network, sequentially. If user device 210 is associated with a high priority class, base station 220 is to allow user device 210 to connect to the LTE network, based on access rule 510.

Alternatively, if user device 210 is associated with a medium priority class, base station 220 is to deny access to the LTE network based on access rule 510, but is to allow user device 210 to connect to the CDMA DO network.

Alternatively, if user device 210 is associated with a low priority class, base station 220 is to deny access to the LTE and CDMA DO networks based on access rule 510. Furthermore, base station 220 is also to deny access to the CDMA 1x network based on access rule 520. In this case, base station 220 drops the connection request by user device 210 based on the lack of additional access capabilities.

As indicated above, FIG. 5 is provided merely as an example. Other examples are possible and may differ from what was described with regard to FIG. 5.

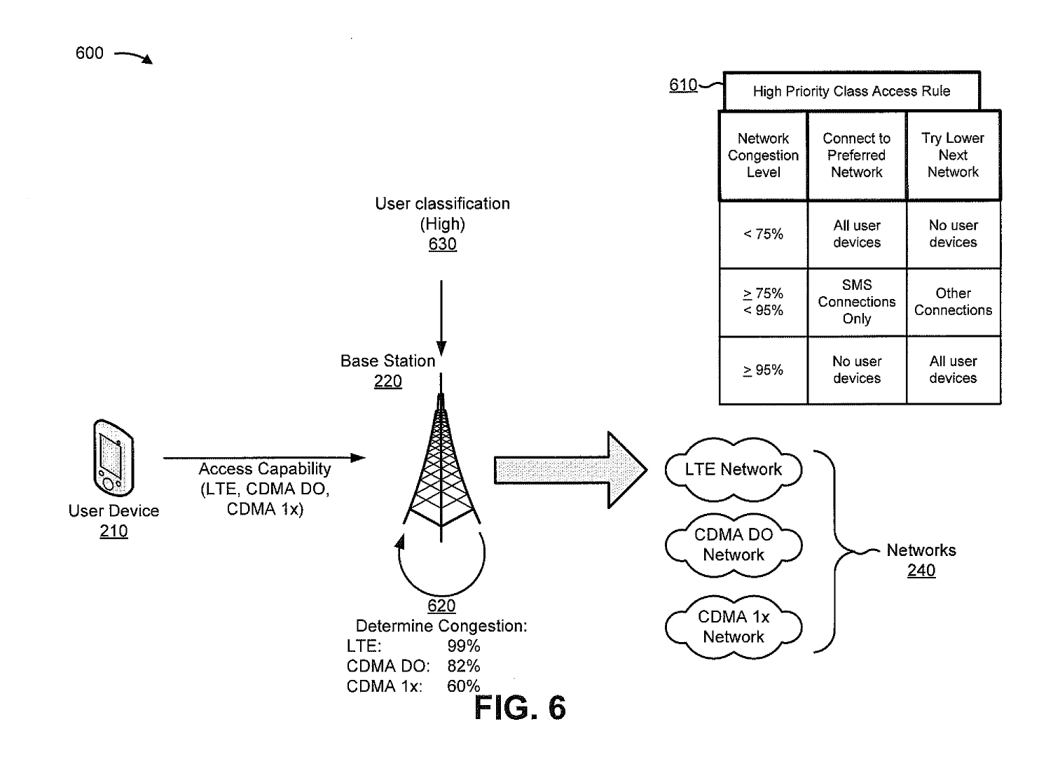

FIG. 6 is a diagram of another example implementation 600 relating to process 400 shown in FIG. 4. In example implementation 600, base station 220 may store access rule 610 to be used for determining whether high priority user devices 210 are granted a network connection. As shown in FIG. 6, base station 220 may receive a connection request from user device 210. The connection request may include information associated with access capabilities of user device 210. For example, assume that the access capabilities associated with user device 210 identify networks 240, such as an LTE network, a CDMA DO network, and a CDMA 1x network.

As shown by reference number 620, base station 220 determines a network congestion level associated with the accessible networks. For example, assume that base station 220 determines network congestion to be 99% for the LTE network, 82% for the CDMA DO network, and 60% for the CDMA 1x network. Assume that because the 99% network congestion level associated with the LTE network exceeds a threshold level of 75%, the LTE network is congested.

As shown by reference number 630, base station 220 determines the priority class for user device 210. For example, assume that user device 210 is classified as high priority.

As further shown in FIG. 6, base station 220 may apply access rule 610 to determine whether to connect user device 210 to the LTE network. For example, when the LTE network congestion level is 99%, base station 220 is to reject a connection based on access rule 610 which specifies that no user devices 210 are to be connected to a network with a network congestion level greater than or equal to 95%.

Failing to connect user device 210 to the LTE network, base station 220 is to apply access rule 610 for the 82% congestion level associated with the CDMA DO network. In this case, base station 220 may determine to connect user device 210 for a particular intended protocol. For example, access rule 610 allows connections for SMS messaging and bars connections for other uses, such as MMS, internet access, streaming voice transmission, or the like.

Assume that user device 210 intends to connect for a barred intended protocol, such as MMS. In this case, base station 220 is to apply access rule 610 to the 60% congestion level associated with the CDMA 1x network. For a congestion level below 75%, base station 220 is to connect user device 210 to the CDMA 1x network based on access rule 610.

As indicated above, FIG. 6 is provided merely as an example. Other examples are possible and may differ from what was described with regard to FIG. 6.

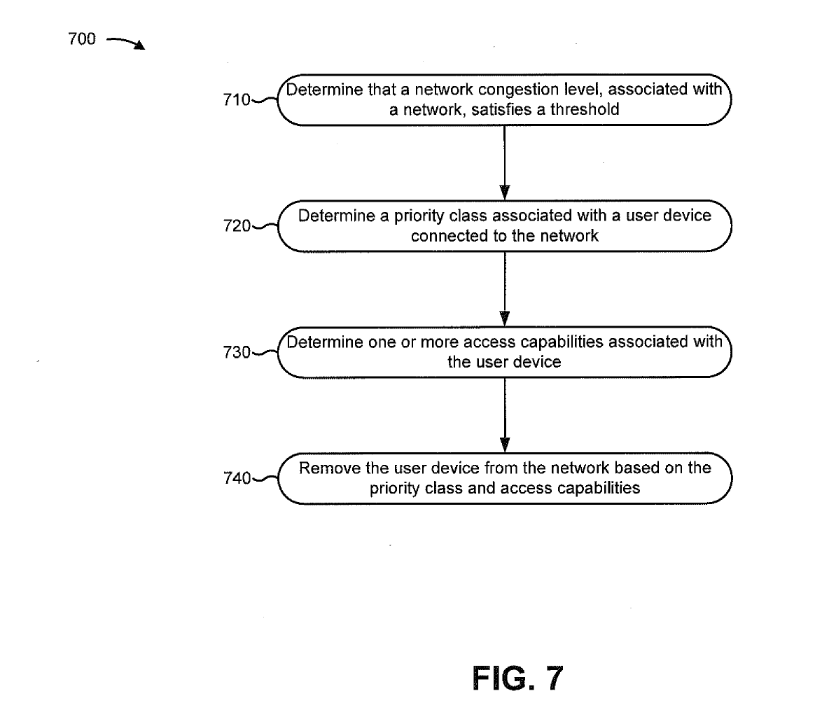

FIG. 7 is a flow chart of an example process 700 for providing tier-based congestion balancing. In some implementations, one or more process blocks of FIG. 7 may be performed by base station 220. Additionally, or alternatively, one or more process blocks of FIG. 7 may be performed by another device or a group of devices separate from or including base station 220, such as user device 210 and/or HSS 230.

As shown in FIG. 7, process 700 may include determining that a network congestion level, associated with a network, satisfies a threshold (block 710). For example, base station 220 may determine that one or more networks 240 have exceeded a threshold level of network congestion, as described herein in connection with FIG. 4.

As shown in FIG. 7, process 700 may include determining a priority class associated with a user device connected to the network (block 720). For example, base station 220 may determine the priority class associated with one or more user devices 210 connected to networks 240, as described herein in connection with FIG. 4.

Base station 220 may determine the priority class associated with user device 210 based on current usage of user device 210, in some implementations. For example, base station 220 may determine that user device 210 is involved in an active connection (e.g., connected for a phone call, downloading data, etc.). In this case, base station 220 may determine that user device 210 is to be treated as being associated with a high priority class in order to avoid interrupting the active connection. Alternatively, base station 220 may determine that user device 210 is not involved in an active connection (e.g., not connected for a phone call, not downloading data, etc.). In this case, base station 220 may determine that user device 210 is to be treated as being associated with a low priority class. Base station 220 may treat user device 210 accordingly.

Current usage may be determined from the utilization level of the bearer channels associated with user device 210, in some implementations. For example, base station 220 may determine that the utilization level (e.g., data throughput, bandwidth usage, etc.) associated with a bearer channel assigned to user device 210 satisfies a threshold.

As shown in FIG. 7, process 700 may include determining one or more access capabilities associated with the user device (block 730). For example, base station 220 may determine one or more access capabilities identifying one or more other networks 240 to which user device 210 may be capable of being connected, as described herein in connection with FIG. 4.

As further shown in FIG. 7, process 700 may include removing the user device from the network based on the priority class and access capabilities (block 740). For example, base station 220 may remove user device 210 from a congested first network 240. In some implementations, base station 220 may remove user device 210 from the congested first network 240, and may assign user device 210 to an uncongested second network 240. For example, base station 220 may determine to remove a low priority class user device 210 from a premium first network 240, such as an LTE network, and assign user device 210 to a non-premium second network 240, such as a CDMA DO network. Alternatively, if user device 210 has no other access capabilities, base station 220 may disconnect user device 210 from the first network without reassigning user device 210 to a second network.

Base station 220 may assign user device 210 to a second network based on the congestion level of the second network, in some implementations. For example, base station 220 may determine that the congestion level associated with the second network does not satisfy a threshold, and may assign user device 210 to the second network. In this way, network congestion may be managed by reassigning user devices from congested premium networks to uncongested non-premium networks, or by disconnecting user devices from the congested premium networks.

Although FIG. 7 shows example blocks of process 700, in some implementations, process 700 may include additional blocks, different blocks, fewer blocks, or differently arranged blocks than those depicted in FIG. 7. Additionally, or alternatively, one or more of the blocks of process 700 may be performed in parallel.

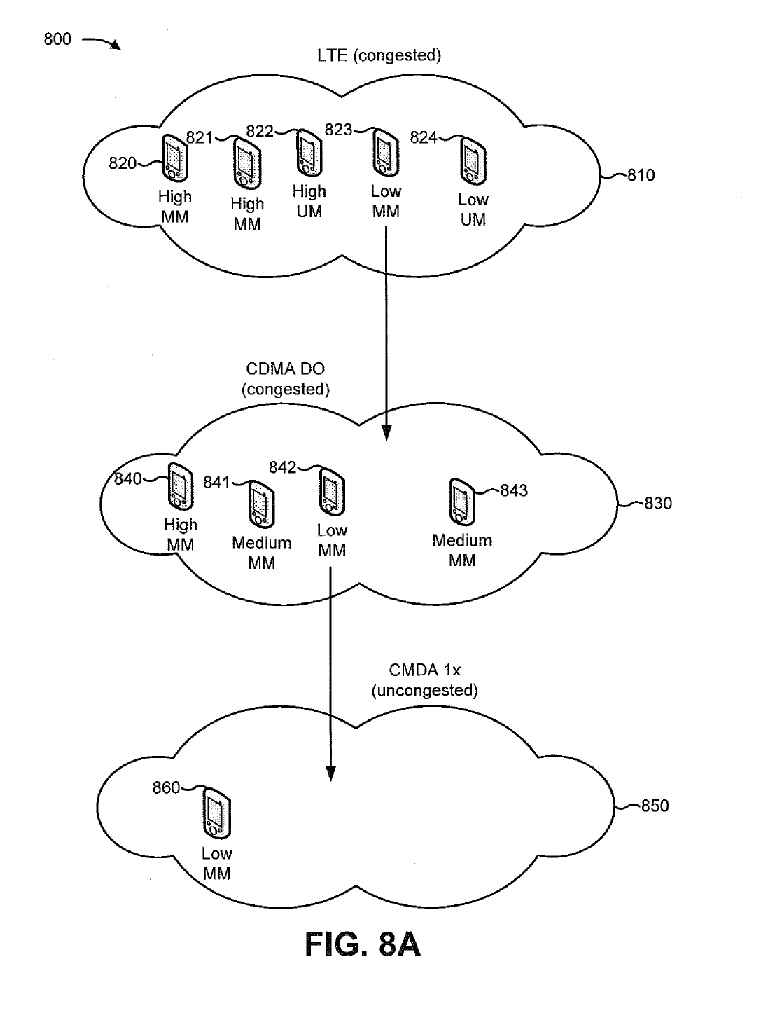

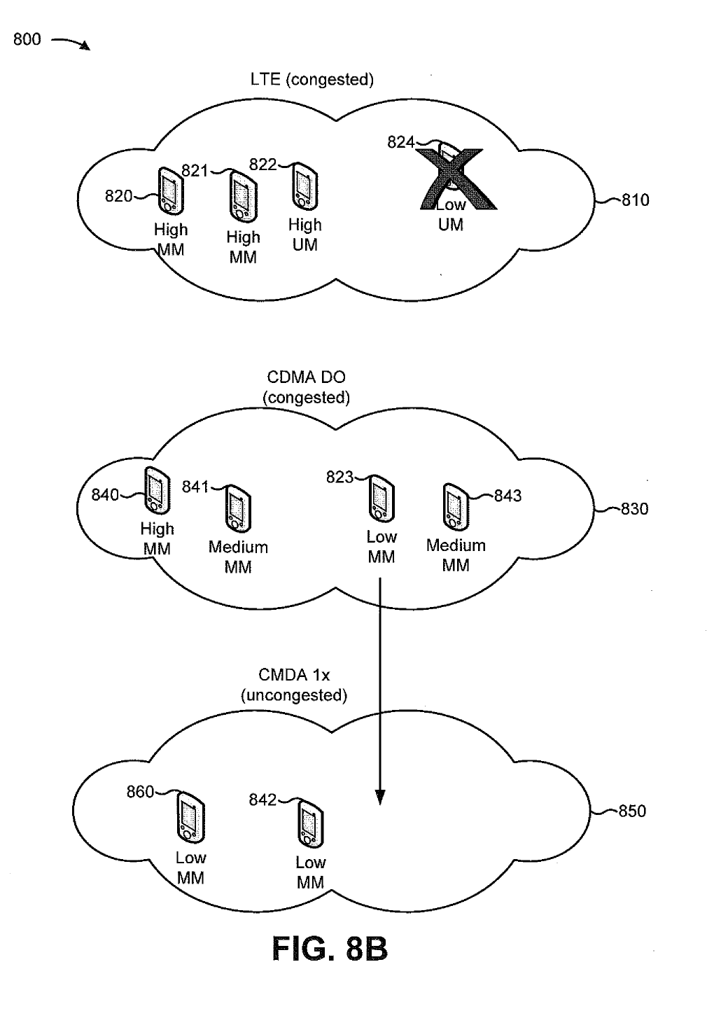

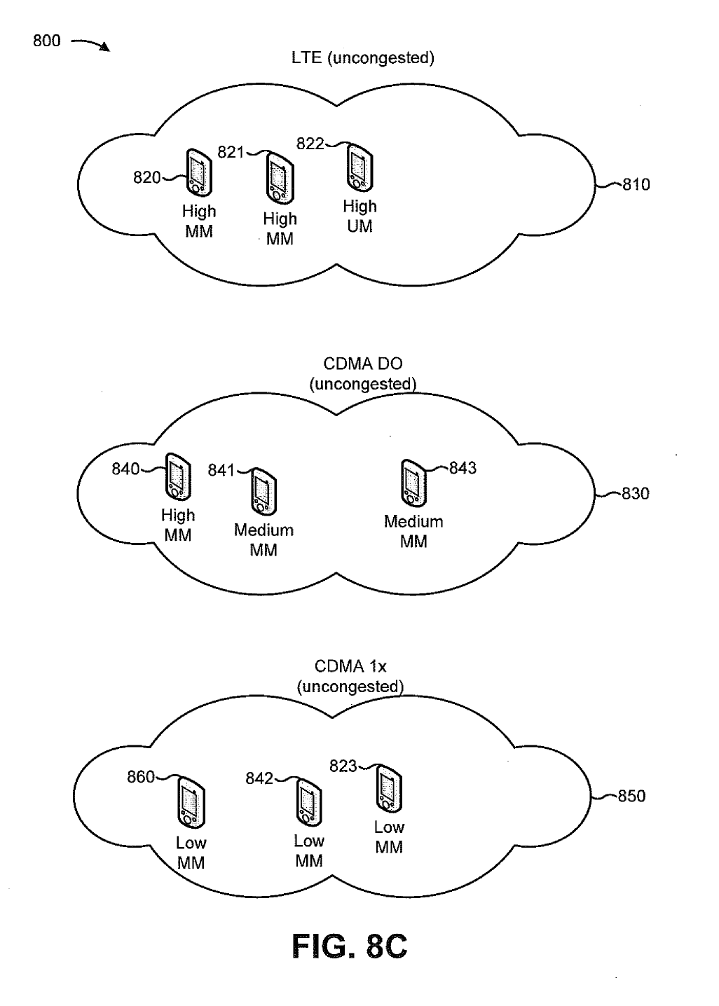

FIGS. 8A, 8B, and 8C are diagrams of an example implementation 800 relating to process 700 shown in FIG. 7. As shown in FIGS. 8A, 8B, and 8C, assume that example implementation 800 includes base station 220 (not shown); network 810, an LTE network with connected user devices 820-824; network 830, a CDMA DO network with connected user devices 840-843; and network 850, a CDMA 1x network with connected user device 860. Assume that base station 220 determines a preferential order for the networks from most preferred to least preferred: network 810, followed by network 830, followed by network 850. Assume that each of the user devices has a priority class of high, medium, or low. Assume that each of the user devices is either unimodal (“UM”) or multimodal (“MM”), where unimodal refers to a single access capability and multimodal refers to multiple access capabilities. Assume that multimodal devices are capable of connecting to any of networks 810, 830, and 850. Further assume that a network with more than three devices has exceeded a threshold congestion level. For example, in FIG. 8A, network 810 and network 830 are congested.

As shown in FIG. 8A, base station 220 determines a user device to reassign from a congested network based on the access capabilities and the priority class of the user device. For example, user device 823 is low priority and multimodal and is, therefore, to be reassigned from congested network 810 to the next most preferred network, network 830. Likewise, user device 842 is low priority and multimodal and is, therefore, determined to be reassigned from congested network 830 to the next most preferred network, network 850.

As shown in FIG. 8B, user device 823 has been reassigned to network 830 and user device 842 has been reassigned to network 850. Assume that base station 220 determines network 810 and network 830 to still be congested (e.g., exceeding the threshold level of three devices per network). Base station 220 may determine a user device to be reassigned from network 810 based on the access capabilities and priority class of the user device. For example, base station 220 may determine that user device 824 is to be reassigned based on having a low priority class. Because user device 824 is unimodal, it is unable to connect to another network and is, therefore, disconnected from network 810 without being reassigned.

Base station 220 may determine a user device on network 830 to be reassigned from network 810 based on the access capabilities and priority class of the user device. For example, base station 220 may determine that user device 823 is to be reassigned based on having a low priority class. Because user device 823 is multimodal, user device 823 is to be reassigned from congested network 830 to the next most preferred network, network 850.

As further shown in FIG. 8C, user device 824 (not shown) has been removed from network 810 and user device 823 has been reassigned from network 830 to network 850. Base station 220 may now determine that none of the networks are congested (e.g., none of the networks exceeds the threshold level of three connected user devices per network).

As indicated above, FIGS. 8A, 8B, and 8C are provided merely as an example. Other examples are possible and may differ from what was described with regard to FIGS. 8A, 8B, and 8C.

Implementations described herein may allow a base station to manage connection requests through tier-based congestion control based on user device access capabilities, network congestion levels, and/or user device priority classes. In so doing, the base station may allocate premium network resources to premium users. Furthermore, implementations described herein may assist a base station in balancing network congestion levels by reassigning user devices connected to congested networks.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive, from a user device, a connection request,
the connection request corresponding to a request to access a first network;
determine a network congestion level associated with the first network;
determine that the network congestion level, associated with the first network, satisfies a threshold;
determine priority class information associated with the user device based on determining that the network congestion level satisfies the threshold;
deny the user device access to the first network based on the network congestion level and the priority class information;
determine that a second network is available based on the user device being denied access to the first network; and
selectively provide the user device with access to the second network.

2. The device of claim 1, where the one or more processors are further to:
determine a connection purpose associated with the connection request; and
change the priority class information based on the connection purpose.

3. The device of claim 1, where the one or more processors are further to:
determine a location of the user device; and
change the priority class information based on the location of the user device.

4. The device of claim 1, where the one or more processors are further to:
receive subscription class information associated with the user device; and
where the one or more processors, when determining the priority class information associated with the user device, are further to:
determine the priority class information based on the received subscription class information.

5. The device of claim 1, where the one or more processors are further to:
determine one or more access capabilities associated with the user device,
the one or more access capabilities identifying one or more networks to which the user device is capable of connecting; and
where the one or more processors, when denying the user device access to the first network, are further to:
deny the user device access to the first network further based on determining that the one or more access capabilities indicate that the user device is capable of connecting to the second network.

6. The device of claim 5, where the one or more processors, when selectively providing the user device with access to the second network, are further to:
selectively provide the user device with access to the second network based on determining that the one or more access capabilities indicate that the user device is capable of connecting to the second network.

7. The device of claim 1, where the one or more processors, when selectively providing the user device with access to the second network, are further to:
deny the user device access to the second network based on the priority class information.

8. The device of claim 1, where the one or more processors, when selectively providing the user device with access to the second network, are further to:
deny the user device access to the second network based on a network congestion level associated with the second network.

9. A computer readable medium storing instructions, the instructions comprising:
one or more instructions that, when executed by one or more processors, cause the one or more processors to:
receive, from a user device, a connection request,
the connection request corresponding to a request to access a first network;
determine a network congestion level associated with the first network;
determine priority class information associated with the user device;
selectively provide access to the first network based on the network congestion level and the priority class information; and
selectively provide access to a second network when access to the first network is denied.

10. The computer readable medium of claim 9, where the one or more instructions, when executed by the one or more processors, further cause the one or more processors to:
receive subscription information associated with the user device; and
where the one or more instructions, when causing the one or more processors to determine the priority class information associated with the user device, further cause the one or more processors to:
determine the priority class information based on the received subscription information.

11. The computer readable medium of claim 9, where the one or more instructions, when executed by the one or more processors, further cause the one or more processors to:
receive information associated with a type of the user device;
determine one or more access capabilities associated with the user device based on the type of the user device; and
where the one or more instructions, when causing the one or more processors to selectively provide access to the first network, further cause the one or more processors to:
selectively provide the user device with access to the first network further based on the one or more access capabilities.

12. The computer readable medium of claim 9, where the one or more instructions, that cause the one or more processors to selectively provide access to the second network, further cause the one or more processors to:
determine an ordering of networks,
the ordering of networks indicating an order of one or more networks to which the user device is capable of being connected; and
determine the second network based on the ordering of networks.

13. The computer readable medium of claim 9, where the one or more instructions, that cause the one or more processors to selectively provide access to the second network, further cause the one or more processors to:
deny the user device access to the second network until the network congestion level satisfies a threshold.

14. A method, comprising:
determining, by a network device, that a network congestion level, associated with a network, satisfies a threshold;
determining, by the network device and based on determining that the network congestion level satisfies the threshold, priority class information associated with a user device connected to the network;
determining, by the network device and based on determining that the network congestion level satisfies the threshold, one or more access capabilities associated with the user device;
determining, by the network device, to disconnect the user device from the network based on the priority class information and the one or more access capabilities; and
causing the user device to be disconnected from the network.

15. The method of claim 14, further comprising:
determining another network based on the one or more access capabilities associated with the user device;
determining a congestion level associated with the other network; and
selectively providing the user device with access to the other network based on the one or more access capabilities associated with the user device, the congestion level associated with the other network, and the priority class information.

16. The method of claim 14, further comprising:
receiving subscription class information associated with the user device; and
where determining the priority class information associated with the user device further comprises:
determining the priority class information based on the received subscription class information.

17. The method of claim 14, further comprising:
determining a plurality of other networks based on the one or more access capabilities associated with the user device;
determining a network congestion level associated with each of the plurality of other networks;
determining a particular network, of the plurality of other networks, based on the network congestion level associated with each of the plurality of networks and the priority class information; and
selectively providing the user device with access to the particular network.

18. The method of claim 14, further comprising:
determining a period of time to deny access to the network based on the network congestion level; and
where causing the user device to be disconnected from the network further comprises:
causing the user device to be denied access to the network for the period of time.

19. The method of claim 14, further comprising:
determining, by the network device, that the user device is not involved in an active connection; and
where determining to disconnect the user device from the network further comprises:
selectively disconnecting the user device from the network based on the user device not being involved in an active connection.

20. The method of claim 19, further comprising:
determining a bearer channel associated with the user device;
determining a utilization level associated with the bearer channel; and
where determining that the user device is not involved in an active connection further comprises:
determining that the user device is not involved in an active connection based on the utilization level satisfying a threshold.
